(19) United States
(12) Patent Application Publication
(10) Pub. No.: US 2025/0083186 A1
(43) Pub. Date: Mar. 13, 2025

(54) AEROSOL GENERATING DEVICE WITH DRIVING CIRCUIT MATCHING THE IMPEDANCE OF ULTRASONIC VIBRATOR

(71) Applicant: KT&G CORPORATION, Daejeon (KR)

(72) Inventors: Jangwon SEO, Daejeon (KR); Gyung Min GO, Daejeon (KR); Chul Ho JANG, Bucheon-si (KR); Jin Chul JUNG, Daejeon (KR)

(73) Assignee: KT&G CORPORATION, Daejeon (KR)

(21) Appl. No.: 18/567,958

(22) PCT Filed: Jul. 14, 2023
(86) PCT No.: PCT/KR2023/010091

§ 371 Date: Dec. 7, 2023

(30) Foreign Application Priority Data
Jul. 20, 2022 (KR) 10-2022-0089699
Oct. 28, 2022 (KR) 10-2022-0141515

(51) Int. Cl. B06B 1/02; A24F 40/05; A24F 40/40; A24F 40/50

(52) U.S. Cl. CPC B06B 1/0207; A24F 40/05; A24F 40/40; A24F 40/50; B06B 2201/55; B06B 2201/77

(57) ABSTRACT

According to an example embodiment, a drive circuit for supplying power to a vibrator includes one or more capacitors connected in parallel, an inductor connected to a first electrical contact point, a switch having a drain terminal connected to the first electrical contact point, a first power source configured to provide a voltage to a gate terminal of the switch, a second power source configured to provide a voltage to a second end of the inductor, and a resistor connected between the gate terminal of the switch and the ground.

### TECHNICAL FIELD

The present disclosure relates to an aerosol generating device, and more particularly, to an impedance matching drive circuit of an aerosol generating device.

### BACKGROUND ART

The demand for electronic cigarettes (i.e., e-cigarettes) has been on a gradual rise. The rising demand for e-cigarettes has accelerated the continued development of e-cigarette related functions. The e-cigarette related functions may include, in particular, functions according to types and characteristics of e-cigarettes.

### DISCLOSURE OF INVENTION

### Technical Problem

An aspect of the present disclosure may provide an impedance matching drive circuit of an aerosol generating device.

An aspect of the present disclosure may provide an aerosol generating device that generates aerosols.

### Solution to Problem

According to an aspect, there is provided a drive circuit including: a first electrical contact point that is connectable to a first end of a vibrator included in a cartridge and a second electrical contact point that is connectable to a second end of the vibrator; one or more capacitors connected in parallel between the first electrical contact point and the second electrical contact point, wherein a first end of the one or more capacitors is connected to the first electrical contact point and a second end of the one or more capacitors is connected to the second electrical contact point; an inductor connected to the first electrical contact point, wherein a first end of the inductor is connected to the first electrical contact point; a switch having a drain terminal connected to the first electrical contact point, wherein a source terminal of the switch is connected to a ground; a first power source configured to provide a voltage to a gate terminal of the switch; a second power source configured to provide a voltage to a second end of the inductor; and a resistor connected between the gate terminal of the switch and the ground.

The drive circuit may further include: one or more matching inductors connected in parallel between the first electrical contact point and the first end of the inductor, wherein a first end of the one or more matching inductors is connected to the first electrical contact point, and a second end of the one or more matching inductors is connected to the drain terminal of the switch.

The drive circuit may further include: a switch connected between the first end of the one or more capacitors and the first electrical contact point, or between the second end of the one or more capacitors and the second electrical contact point.

The drive circuit may further include: a switch connected in parallel with the one or more matching inductors.

The first power source may be configured to provide an alternating current (AC) voltage to the gate terminal of the switch.

The second power source may be configured to provide a direct current (DC) voltage to the second end of the inductor and the first end of the vibrator.

According to an aspect, there is provided an electronic cigarette including the above-described drive circuit.

According to an aspect, there is provided a drive circuit of an electronic device, including: a first electrical contact point that is connectable to a first end of a vibrator included in a cartridge and a second electrical contact point that is connectable to a second end of the vibrator; one or more matching inductors connected to the first electrical contact point, wherein a first end of the one or more matching inductors is connected to the first electrical contact point and the one or more matching inductors are connected in parallel; an inductor connected to a second end of the one or more matching inductors, wherein a first end of the inductor is connected to the second end of the one or more matching inductors; a switch having a drain terminal connected to the second end of the one or more matching inductors, wherein a source terminal of the switch is connected to a ground; a first power source configured to provide a voltage to a gate terminal of the switch; a second power source configured to provide a voltage to a second end of the inductor; and a resistor connected between the gate terminal of the switch and the ground.

According to an aspect, them is provided an electronic device including a body configured to be connected to a cartridge, wherein the body may include: a driver circuit configured to, when the cartridge is connected to the body, drive a vibrator of the cartridge; and a controller configured to control an operation of the drive circuit. The drive circuit may include: a first electrical contact point that is connectable to a first end of the vibrator and a second electrical contact point that is connectable to a second end of the vibrator; one or more capacitors connected in parallel between the first electrical contact point and the second electrical contact point, wherein a first end of the one or more capacitors is connected to the first electrical contact point and a second end of the one or more capacitors is connected to the second electrical contact point; an inductor connected to the first electrical contact point, wherein a first end of the inductor is connected to the first electrical contact point; a switch having a drain terminal connected to the first electrical contact point, wherein a source terminal of the switch is connected to a ground; a first power source configured to provide a voltage to a gate terminal of the switch; a second power source configured to provide a voltage to a second end of the inductor; and a resistor connected between the gate terminal of the switch and the ground.

According to an aspect, there is provided an electronic device including a body configured to be connected to a cartridge, wherein the body may include: a driver circuit configured to, when the cartridge is connected to the body, drive a vibrator of the cartridge; and a controller configured to control an operation of the drive circuit. The drive circuit may include: a first electrical contact point that is connectable to a first end of the vibrator and a second electrical contact point that is connectable to a second end of the vibrator; one or more matching inductors connected to the first electrical contact point, wherein a first end of the one or more matching inductors is connected to the first electrical contact point and the one or more matching inductors are connected in parallel; an inductor connected to a second end of the one or more matching inductors, wherein a first end of the inductor is connected to the second end of the one or more matching inductors; a switch having a drain terminal connected to the first end of the one or more matching inductors, wherein a source terminal of the switch is connected to a ground; a first power source configured to provide a voltage to a gate terminal of the switch; a second power source configured to provide a voltage to a second end of the inductor; and a resistor connected between the gate terminal of the switch and the ground.

### Advantageous Effects of Invention

According to example embodiments described herein, there is provided a drive circuit for driving a vibrator of an aerosol generating device.

According to example embodiments described herein, there is provided an aerosol generating device for generating aerosols.

### BRIEF DESCRIPTION OF DRAWINGS

FIG. 1 is a block diagram of an aerosol generating device according to an example embodiment.

FIG. 2 is a schematic diagram of an aerosol generating device according to an example embodiment.

FIG. 3 is a perspective view of an aerosol generating device with a cartridge and a body separated from each other according to an example embodiment.

FIG. 4 is a perspective view of an aerosol generating device with a cartridge and a body coupled to each other according to an example embodiment.

FIG. 5a illustrates a drive circuit including a capacitor according to an example embodiment.

FIG. 5b illustrates a drive circuit including a matching inductor according to an example embodiment.

FIG. 5c illustrates a drive circuit including a capacitor and a matching inductor according to an example embodiment.

FIG. 6 illustrates a full bridge drive circuit according to an example embodiment.

FIG. 7 illustrates a drive circuit for switching between a full-bridge mode and a half-bridge mode according to an example embodiment.

FIG. 8 illustrates an equivalent circuit of a drive circuit operating in a half-bridge mode according to an example embodiment.

### MODE FOR THE INVENTION

The following detailed structural or functional description is provided only for illustrative purposes, and various alterations and modifications may be made to examples. Here, examples are not construed as limited to the disclosure and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a first component may be referred to as a second component, and similarly the second component may also be referred to as the first component.

It should be noted that, if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise, it will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

As used herein. “at least one of A, B, and C” and “at least one of A, B, or C” should be understood as including only a, only b, only c, both a and b, both a and c, both b and c, or all of a, b, and c.

Unless otherwise defined, all terms, including technical and scientific terms, used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like components and a repeated description related thereto will be omitted.

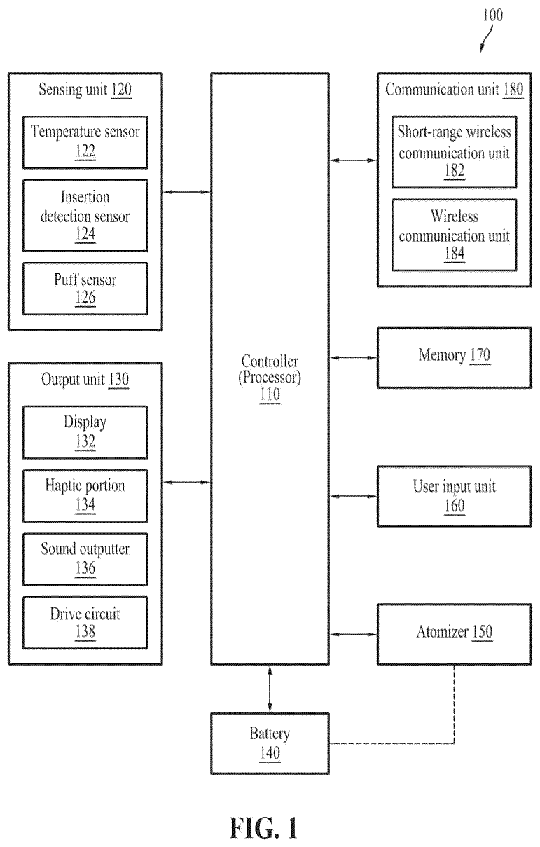

FIG. 1 is a block diagram of an aerosol generating device according to an example embodiment.

According to an example embodiment, an aerosol generating device 100 of FIG. 1 may include a controller 110, a sensing unit 120, an output unit 130, a battery 140, an atomizer 150, a user input unit 160, a memory 170, and a communication unit 180. However, the internal structure of the aerosol generating device 100 is not limited to what is shown in FIG. 1. It is to be understood by one of ordinary skill in the art to which the present disclosure pertains that some of the components shown in FIG. 1 may be omitted or new components may be added according to the design of the aerosol generating device 100.

The sensing unit 120 may sense a state of the aerosol generating device 100 or a state of an environment around the aerosol generating device 100 and transmit sensed information to the controller 110. Based on the sensed information, the controller 110 may control the aerosol generating device 100 to perform various functions, such as, for example, controlling an operation of the atomizer 150, restricting smoking, determining whether an aerosol-generating item (e.g., an aerosol-generating material, a cartridge, etc.) is inserted, and displaying a notification.

The sensing unit 120 may include at least one of a temperature sensor 122, an insertion detection sensor 124, or a puff sensor 126, but examples of which am not limited thereto.

The temperature sensor 122 may sense a temperature of the atomizer 150 (or an aerosol-generating material). The aerosol generating device 100 may include a separate temperature sensor for sensing the temperature of the atomizer 150, or the atomizer 150 itself may perform a function as such a temperature sensor. Alternatively, the temperature sensor 122 may be disposed around the battery 140 to monitor a temperature of the battery 140.

The insertion detection sensor 124 may sense whether the aerosol-generating item is inserted or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion or removal of the aerosol-generating item.

The puff sensor 126 may sense a puff from a user based on various physical changes in an airflow path or channel. For example, the puff sensor 126 may sense the puff of the user based on any one of a temperature change, a flow change, a voltage change, and a pressure change.

The sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 through 126 described above. A function of each sensor may be intuitively inferred from its name by one of ordinary skill in the art, and thus a more detailed description thereof will be omitted here.

The output unit 130 may output the information about the state of the aerosol generating device 100 and provide the information to the user. The output unit 130 may include at least one of a display 132, a haptic portion 134 or a sound outputter 136, but examples of which are not, limited thereto. When the display 132 and a touchpad are provided in a layered structure to form a touchscreen, the display 132 may be used as an input device in addition to an output device.

The display 132 may visually provide information about the aerosol generating device 100 to the user. The information about the aerosol generating device 100 may include various pieces of information, for example, a charging/discharging state of the battery 140 of the aerosol generating device 100, a state of the atomizer 150, an insertion/removal state of the aerosol-generating item, a limited usage state (e.g., an abnormal item detected) of the aerosol generating device 100, or the like, and the display 132 may externally output the information. The display 132 may be provided in a form, for example, a liquid-crystal display (LCD) panel, an organic light-emitting display (OLED) panel, or the like. The display 132 may also be provided in a form of a light-emitting diode (LED) device.

The haptic portion 134 may convert an electrical signal into a mechanical stimulus or an electrical stimulus and provide the information about the aerosol generating device 100 to the user in a haptic way. The haptic portion 134 may include, for example, a motor, a piezoelectric element, or an electrical stimulation device.

The sound outputter 136 may provide the information about the aerosol generating device 100 to the user in an auditory way. For example, the sound outputter 136 may convert an electrical signal into a sound signal and externally output the sound signal.

The battery 140 may supply power to be used to operate the aerosol generating device 100. The battery 140 may supply power to the atomizer 150 to operate it. The battery 140 may also supply power required for other components (e.g., the sensing unit 120, the output unit 130, the user input unit 160, the memory 170, and the communication unit 180) included in the aerosol generating device 100 to perform their operations. The battery 140 may be a rechargeable battery or a disposable battery. The battery 140 may be, for example, a lithium polymer (LiPoly) battery, but examples of which are not limited thereto.

The atomizer 150 may receive the power from the battery 140 to atomize the aerosol-generating material. Although not shown in FIG. 1, the aerosol generating device 100 may further include a power conversion circuit (e.g., a direct current (DC)-to-DC (DC/DC) converter) that converts the power of the battery 140 and supplies the power to the atomizer 150. In addition, when the aerosol generating device 100 generates aerosols through ultrasonic vibration, the aerosol generating device 100 may further include a DC-to-alternating current (AC) (DC/AC) converter that converts DC power of the battery 140 into AC power.

The controller 110, the sensing unit 120, the output unit 130, the user input unit 160, the memory 170, and the communication unit 180 may receive power from the battery 140 to perform their functions. Although not shown in FIG. 1, the aerosol generating device 10 may further include a power conversion circuit, for example, a low dropout (LDO) circuit or a voltage regulator circuit, which converts the power of the battery 140 and supplies the power to the respective components.

According to an example embodiment, the atomizer 150 may include a vibrator configured to generate ultrasonic vibration by an applied signal (e.g., power). For example, a material of the vibrator may include a piezoelectric ceramic, but examples of which are not limited thereto. The vibrator may include a piezoelectric body. According to an example embodiment, the piezoelectric body, which may be a conversion element that converts electrical energy into mechanical energy, may generate ultrasonic vibration under the control of the controller 110. In an example embodiment, when AC power is applied to a piezoelectric body obtained through polarization, the piezoelectric body may repeatedly expand and contract. As the piezoelectric body repeatedly expands and contracts, the vibrator may vibrate at a characteristic frequency. As a signal is applied to the vibrator, a short high-frequency vibration may be generated, and the generated vibration may break the aerosol-generating material into small particles to atomize them into aerosols.

The user input unit 160 may receive information input from the user or may output information to the user. The user input unit 160 may include, for example, a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like, but examples of which are not limited thereto. In addition, although not shown in FIG. 1, the aerosol generating device 100 may further include a connection interface such as a universal serial bus (USB) interface, and may use the connection interface such as the USB interface to be connected to another external device so as to transmit and receive information or charge the battery 140.

The memory 170, which is hardware for storing various pieces of data processed in the aerosol generating device 100, may store data that has been processed or to be processed by the controller 110. The memory 170 may include at least one type of storage medium including, for example, a flash memory type memory, a hard disk type memory, a multimedia card micro type memory, a card type memory (e.g., SD or XE memory), a random-access memory (RAM), a static RAM (SRAM), a read-only memory (ROM), an electrically erasable programmable ROM (EEPROM), a programmable ROM (PROM), a magnetic memory, a magnetic disk, or an optical disc. The memory 170 may store an operating time of the aerosol generating device 100, a maximum number of puffs, a current number of puffs, at least one temperature profile, data associated with a smoking pattern of the user, or the like.

The communication unit 180 may include at least one component for communicating with another electronic device. For example, the communication unit 180 may include a short-range wireless communication unit 182 and a wireless communication unit 184.

The short-range wireless communication unit 182 may include a Bluetooth communication unit, a Bluetooth low energy (BLE) communication unit, a near-field communication (NFC) unit, a wireless local area network (WL-AN) e.g. Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit, but examples of which are not limited thereto.

The wireless communication unit 184 may include a cellular network communication unit, an Internet communication unit, and a computer network (e.g., a local area network (LAN) or wide-area network (WAN)) communication unit, but examples of which are not limited thereto. The wireless communication unit 184 may use subscriber information (e.g., international mobile subscriber identity (IMSI)) to identify and authenticate the aerosol generating device 100 in a communication network.

The controller 110 may control an overall operation of the aerosol generating device 100. In an example embodiment, the controller 110 may include at least one processor. The processor may be implemented as an array of a plurality of logic gates or as a combination of a general-purpose microprocessor and a memory storing a program executable by the microprocessor. In addition, it is to be understood by one of ordinary skill in the art to which the present disclosure pertains that it may be implemented in other types of hardware.

The controller 110 may control an operation of the atomizer 150 by controlling the supply of power from the battery 140 to the atomizer 150. For example, the controller 110 may control the supply of power by controlling the switching of a switching element of a drive circuit 138 disposed between the battery 140 and the atomizer 150.

The controller 110 may analyze a sensing result obtained by the sensing of the sensing unit 120 and control processes to be performed thereafter. For example, the controller 110 may control power to be supplied to the atomizer 150 to start or end the operation of the atomizer 150 based on the sensing result obtained by the sensing unit 120. As another example, the controller 110 may control an amount of power to be supplied to the atomizer 150 and a time for which the power is to be supplied thereto, such that the atomizer 150 may vibrate at a predetermined frequency or maintain a desired frequency, based on the sensing result obtained by the sensing unit 120.

The controller 110 may control the output unit 130 based on the sensing result obtained by the sensing unit 120. For example, when the number of puffs counted through the puff sensor 126 reaches a preset number, the controller 110 may inform the user that the aerosol generating device 100 is to be ended soon, through at least one of the display 132, the haptic portion 134, or the sound outputter 136.

According to an example embodiment, the controller 110 may control such a power supply time and/or power supply amount for the atomizer 150 by controlling the drive circuit 138 based on a state of the aerosol-generating item sensed by the sensing unit 120. For example, based on a type or remaining amount of the aerosol-generating item, the controller 110 may control a vibration frequency of the vibrator of the atomizer 150.

Example embodiments described herein may be implemented in the form of a recording medium including computer-executable instructions, such as a computer-executable program module. A computer-readable medium may be any available medium that is accessible by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storing information such as computer-readable instructions, data structures, program modules, or other data. The communication medium typically includes computer-readable instructions, data structures, other data in modulated data signals such as program modules, or other transmission mechanisms and includes any information transfer medium.

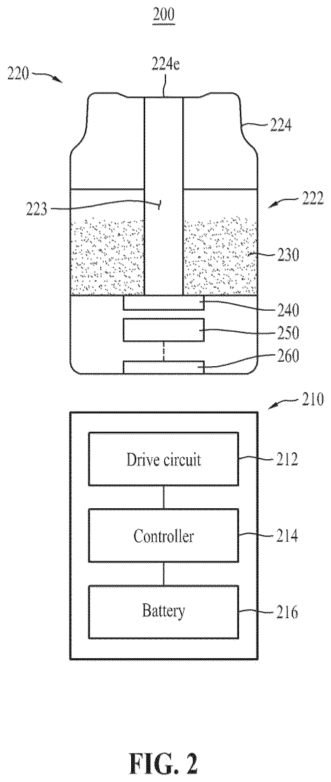

FIG. 2 is a schematic diagram of an aerosol generating device according to an example embodiment.

Referring to FIG. 2, an aerosol generating device 200 (e.g., the aerosol generating device 100 of FIG. 1) may include a cartridge 220 containing an aerosol-generating material and a body 210 connected to the cartridge 220.

The cartridge 220 of the aerosol generating device 200 may be coupled to the body 210 with the aerosol-generating material stored therein. For example, as at least a portion of the cartridge 220 is inserted into the body 210, the cartridge 220 and the body 210 may be coupled. As another example, as at least a portion of the body 210 is inserted into the cartridge 220, the cartridge 220 and the body 210 may be coupled.

The cartridge 220 and the body 210 may be coupled by at least one of a snap-fit method, a screw coupling method, a magnetic coupling method, or an interference fit method, but a method of coupling the cartridge 220 and the body 210 is not limited to the foregoing example methods.

According to an example embodiment, the cartridge 220 may include a housing 222, a mouthpiece 224, a storage portion 230, a transfer portion 240, a vibrator 250, and an electrical terminal 260.

The housing 222 of the aerosol generating device 200 may form an overall outer shape of the cartridge 220 together with the mouthpiece 224, and components for an operation of the cartridge 220 may be disposed inside the housing 222. For example, the housing 222 may be formed in a rectangular parallelepiped shape, but the shape of the housing 222 is not limited to the foregoing example. According to an example embodiment, the housing 222 may be formed in the shape of a polygonal prism (e.g., a triangular prism or a pentagonal prism) or in the shape of a cylinder.

The mouthpiece 224 of the aerosol generating device 200 may be disposed in one area of the housing 222 and include an outlet 224e for discharging an aerosol generated from the aerosol-generating material to the outside. For example, the mouthpiece 224 may be disposed in an area opposite to another area of the cartridge 220 coupled to the body 210. A user may receive an aerosol from the cartridge 220 as he or she brings a mouth into contact with the mouthpiece 224 and inhales.

By the inhalation or puff performed by the user, there may be a pressure difference between the outside of the cartridge 220 and the inside of the cartridge 220, and an aerosol generated in the cartridge 220 may be discharged to the outside of the cartridge 220 via the outlet 224e by the pressure difference between the inside and the outside of the cartridge 220. That is, the user may receive the aerosol discharged to the outside of the cartridge 220 via the outlet 224e as he or she brings a mouth into contact with the mouthpiece 224 and inhales.

The storage portion 230 of the aerosol generating device 200 may be disposed in an inner space of the housing 222 and store the aerosol-generating material. Hereinafter, the expression of “storing an aerosol-generating material” may indicate a function of simply containing the aerosol-generating material, serving as a container, or may involve an additional function of retaining the aerosol-generating material by using sponge, cotton, cloth, or porous ceramic structure.

The storage portion 230 may store the aerosol-generating material in one state, for example, a liquid state, a solid state, a gaseous state, or a gel state.

In an example embodiment, the aerosol-generating material may include a liquid composition. The liquid composition may be, for example, a liquid including a tobacco-containing material that includes a volatile tobacco flavor component or may be a liquid including a non-tobacco material.

The liquid composition may include, for example, one of water, a solvent, ethanol, a plant extract, a fragrance, a flavoring agent, and a vitamin mixture, or include a mixture of these ingredients. The fragrance may include, as non-limiting examples, menthol, peppermint, spearmint oil, various fruit-flavored ingredients, or the like.

The flavoring agent may include an ingredient that provides the user with a variety of flavors or scents. The vitamin mixture may be a mixture of at least one of vitamin A, vitamin B, vitamin C, or vitamin E, but examples of which are not limited thereto. The liquid composition may also include an aerosol former such as glycerin and propylene glycol.

The liquid composition may include, for example, glycerin and propylene glycol in any weight ratio, to which a nicotine salt is added. The liquid composition may also include two or more types of nicotine salt. The nicotine salt may be formed by adding a suitable acid including an organic acid or an inorganic acid to nicotine. The nicotine, which is either naturally generated nicotine or synthetic nicotine, may have a concentration of any appropriate weight relative to a total solution weight of the liquid composition.

The acid for forming the nicotine salt may be appropriately selected in consideration of an absorption rate of nicotine in the blood, an operating temperature of the aerosol generating device 200, a flavor or taste, solubility, and the like. The acid for forming the nicotine salt may include, as non-limiting examples, a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid, or malic acid, or a mixture of two or more acids selected from the foregoing group.

The transfer portion 240 of the aerosol generating device 200 may absorb the aerosol-generating material. For example, the aerosol-generating material stored or contained in the storage portion 230 may be transferred from the storage portion 230 to the vibrator 250 through the transfer portion 240, and the vibrator 250 may generate aerosols by atomizing the aerosol-generating material of the transfer portion 240 or the aerosol-generating material received from the transfer portion 240. In this case, the transfer portion 240 may include at least one of cotton fibers, ceramic fibers, glass fibers, or porous ceramics, but examples of which am not limited thereto.

According to an example embodiment, the transfer portion 240 may be disposed near the storage portion 230 to receive a liquid aerosol-generating material from the storage portion 230. For example, the aerosol-generating material stored in the storage portion 230 may be discharged to the outside of the storage portion 230 through a liquid supply port formed in one area of the storage portion 230 facing toward the transfer portion 240, and the transfer portion 240 may absorb at least a portion of the aerosol-generating material discharged from the storage portion 230 to absorb the aerosol-generating material discharged from the storage portion 230.

According to an example embodiment, the cartridge 220 may further include an absorber (not shown) that is disposed to cover at least a portion of the vibrator 250 where an aerosol is generated and transfers the aerosol-generating material absorbed by the transfer portion 240 to the vibrator 250. The absorber may be formed with a material that absorbs an aerosol-generating material. The absorber may include, for example, at least one material of SPL 30(H), SPL 50(H)V, NP 100(V8), SPL 60(FC), and melamine. As the cartridge 220 further includes the absorber, the aerosol-generating material may thus be absorbed by the absorber in addition to the transfer portion 240, and the amount of the aerosol-generating material being absorbed may thus be improved.

The vibrator 250 of the aerosol generating device 200 may be disposed inside the housing 222 and generate aerosols by converting a phase of the aerosol-generating material stored in the cartridge 220. For example, the vibrator 250 may generate aerosols by heating or vibrating the aerosol-generating material.

In addition, as the absorber is disposed to cover at least a portion of the vibrator 250, the absorber may function as a physical barrier that prevents “spitting” of particles that fail to be fully atomized during an aerosol generating process and are discharged directly to the outside of the aerosol generating device 200. The “spitting” may refer to a phenomenon that some large particles of an aerosol-generating material fail to be fully atomized and are discharged to the outside of the cartridge 220. According to an embodiment, the absorber included in the cartridge 220 may reduce the probability of the spitting, thereby improving the smoking satisfaction of the user.

In an example embodiment, the absorber may be disposed between one surface of the vibrator 250 where an aerosol is generated and the transfer portion 240 so that the aerosol supplied to the transfer portion 240 is transferred to the vibrator 250. For example, one area of the absorber may contact one area of the transfer portion 240 facing a −z direction, and another area of the absorber may contact one area of the vibrator 250 facing a +z direction. That is, the absorber may be disposed on a top surface (e.g., in the +z direction) of the vibrator 250 to supply the aerosol-generating material absorbed by the transfer portion 240 to the vibrator 250.

According to an example embodiment, the vibrator 250 of the aerosol generating device 200 may change a phase of the aerosol-generating material, using an ultrasonic vibration method that atomizes the aerosol-generating material through ultrasonic vibration. For example, the vibrator 250 may generate vibration having a short period, and the vibration generated from the vibrator 250 may be ultrasonic vibration. A frequency of the ultrasonic vibration may be in a range of approximately 100 kilohertz (kHz) to approximately 10 megahertz (MHz) (desirably, in a range of approximately 100 kHz to 3.5 MHz), but examples of which are not limited thereto. As the vibrator 250 generates ultrasonic vibration of such a frequency band as described above, the vibrator 250 may vibrate in a longitudinal direction (e.g., a z-axis direction) of the cartridge 220 or the housing 222. However, example embodiments are not limited to the direction in which the vibrator 250 vibrates, and the direction in which the vibrator 250 vibrates may be changed to various directions (e.g., one of an x-axis direction, a y-axis direction, and a z-axis direction or a combination thereof). The aerosol-generating material supplied from the storage portion 230 to the vibrator 250 by such a short-period vibration generated from the vibrator 250 may be vaporized and/or changed into particles to be atomized into aerosols.

For example, the vibrator 250 may include a piezoelectric ceramic, and the piezo-electric ceramic may be a functional material that generates power (or a voltage) by a physical force (or a pressure) and reversely generates a vibration (or a mechanical force) at the application of the power to convert the power and the mechanical force reciprocally. That is, as the power is applied to the vibrator 250, the short-period vibration (or the physical force) may be generated, and the generated vibration may break the aerosol-generating material into small particles and atomize the aerosol-generating material into aerosols.

The vibrator 250 may be electrically connected to other components of the aerosol generating device 200 through the electrical terminal 260. The electrical terminal 260 may be disposed on one surface of the cartridge 220. For example, the electrical terminal 260 may be disposed on a coupling surface of the cartridge 220 where the cartridge 220 is coupled to the body 210 of the aerosol generating device 200. The electrical terminal 260 may be disposed on one surface of the housing 222 opposite the mouthpiece 224.

According to an example embodiment, the vibrator 250 may be electrically connected to at least one of a drive circuit 212, a controller 214, or a battery 216 of the body 210 through the electrical terminal 260 disposed inside the housing 222 of the cartridge 220.

For example, the vibrator 250 may be electrically connected to the electrical terminal 260 disposed inside the cartridge 220 through a first conductor, and the electrical terminal 260 may be electrically connected to the drive circuit 212 of the body 210 through a second conductor. That is, the vibrator 250 may be electrically connected to components of the body 210 through the electrical terminal 260 as a medium.

The vibrator 250 may generate ultrasonic vibration by receiving power from the battery 216 of the body 210 through the electrical terminal 260. In addition, the vibrator 250 may be electrically connected to the controller 214 of the body 210 through the electrical terminal 260, and the controller 214 may control an operation of the vibrator 250 through the drive circuit 212.

The electrical terminal 260 may include, for example, at least one of a pogo pin, a wire, a cable, a printed circuit board (PCB), a flexible PCB (FPCB), or a C-clip, but the electrical terminal 260 is not limited to the foregoing examples.

In an example embodiment, the vibrator 250 may be implemented as a mesh-shaped or plate-shaped vibration receiving portion that performs both a function of absorbing an aerosol-generating material and maintaining the aerosol-generating material in an optimal state to be converted into aerosols and a function of transferring vibration to the aerosol-generating material to generate aerosols, without using a separate transfer portion (e.g., the transfer portion 240).

The aerosols generated by the vibrator 250 may be discharged to the outside of the cartridge 220 through an airflow path 223 to be supplied to the user.

According to an example embodiment, the airflow path 223 may be positioned inside the cartridge 220 and may be connected to the vibrator 250 and the outlet 224e of the mouthpiece 224. Accordingly, the aerosols generated by the vibrator 250 may flow along the airflow path 223 and may be discharged to the outside of the cartridge 220 or the aerosol generating device 200 through the outlet 224e. The user may receive the aerosols as the user brings their mouth into contact with the mouthpiece 224 and inhales the aerosols discharged from the outlet 224e.

Although not shown in the drawings, the airflow path 223 may include at least one inlet through which air outside the cartridge 220 is introduced into the cartridge 220. The inlet may be disposed in at least a portion of the housing 222 of the cartridge 220. For example, the inlet may be disposed on a coupling surface (e.g., a bottom surface) of the cartridge 220 where the cartridge 221) and the body 210 are coupled.

In this case, there may be at least one gap in a portion where the cartridge 220 and the body 210 are coupled, and external air may thus be introduced through the gap between the cartridge 220 and the body 210 to move into the cartridge 220 through the inlet.

The airflow path 223 may be connected from the inlet to a space where an aerosol is generated by the vibrator 250 and may be connected from the space to the outlet 224e.

Accordingly, the air introduced through the inlet may be transferred to the vibrator 250, and the transferred air may move to the outlet 224c together with the aerosol generated by the vibrator 250, thereby circulating the air inside the cartridge 220.

In an example embodiment, at least a portion of the airflow path 223 may be arranged such that an outer circumferential surface is surrounded by the storage portion 230 in the housing 222. In another example embodiment, at least a portion of the airflow path 223 may be arranged between an inner wall of the housing 222 and an outer wall of the storage portion 230. An arrangement structure of the airflow path 223 is not limited to the foregoing examples, and the airflow path 223 may be arranged in various structures to circulate the airflow between the inlet, the vibrator 250, and the outlet 224e.

According to an example embodiment, the body 210 may include the drive circuit 212, the controller 214, and the battery 216 therein, and one end portion of the body 210 may be connected to one end portion of the cartridge 220. For example, the body 210 may be coupled to the bottom surface or the coupling surface of the cartridge 220.

When the vibrator 250 of the cartridge 220 is electrically connected to the drive circuit 212 through the electrical terminal 260, the drive circuit 212 may supply power to the vibrator 250. For example, a magnitude of the power supplied to the vibrator 250 may be determined by the controller 214. A vibration frequency of the vibrator 250 or the like may be controlled by the magnitude of the power. According to an example embodiment, the drive circuit 212 may be provided in the form of a class-E power amplifier circuit, a half-bridge circuit, or a full-bridge circuit, but examples of which are not limited thereto.

The controller 214 may control an overall operation of the aerosol generating device 200. For example, the controller 214 may control an amount of aerosol generated by the vibrator 250 by controlling the power supplied from the battery 216 to the vibrator 250. For example, the controller 214 may control the power supplied to the vibrator 250 such that the vibrator 250 may vibrate at a predetermined frequency.

The controller 214 may be implemented as an array of a plurality of logic gates or as a combination of a general-purpose microprocessor and a memory storing therein a program executable by the microprocessor. In addition, it is to be understood by one of ordinary skill in the art to which the present disclosure pertains that the controller 214 may be implemented in other types of hardware.

The controller 214 may analyze a sensing result obtained by at least one sensor included in the aerosol generating device 200 and control subsequent processes to be performed thereafter. For example, the controller 214 may control the power to be supplied to the vibrator 250 to start or end an operation of the vibrator 250 based on the sensing result obtained by the at least one sensor. In addition, the controller 214 may control an amount of power to be supplied to the vibrator 250 and a time for which the power is to be supplied thereto, such that the vibrator 250 may generate an appropriate amount of aerosol based on the sensing result obtained by the at least one sensor.

The battery 216 may supply power to be used to operate the aerosol generating device 200. For example, when the body 210 is electrically coupled to the cartridge 220, the battery 216 may supply power to the vibrator 250.

The battery 216 may supply power required for operations of other hardware components (e.g., a sensor, a user interface, a memory, and the controller 214) included in the aerosol generating device 200. The battery 216 may be a rechargeable battery or a disposable battery.

The battery 216 may include, for example, a nickel-based battery (e.g., a nickel-metal hydride battery or a nickel-cadmium battery) or a lithium-based battery (e.g., a lithium-cobalt battery, a lithium-phosphate battery, a lithium-titanate battery, a lithium-ion battery, or a lithium-polymer battery).

In an example embodiment, a cross-sectional shape viewed in a direction transverse to a longitudinal direction of the cartridge 220 and/or the body 210 of the aerosol generating device 200 may be circular, elliptical, square, rectangular, or various polygonal shapes. However, the cross-sectional shape of the cartridge 220 and/or the body 210 is not limited to the foregoing example shapes or is not necessarily a shape that linearly extends when the aerosol generating device 200 extends in the longitudinal direction.

In an example embodiment, the cross-sectional shape of the aerosol generating device 200 may extend long to be curved in a streamlined shape or bent in a particular area at a preset angle, thereby allowing the user to hold it easier by hand, and the cross-sectional shape of the aerosol generating device 200 may change along the longitudinal direction.

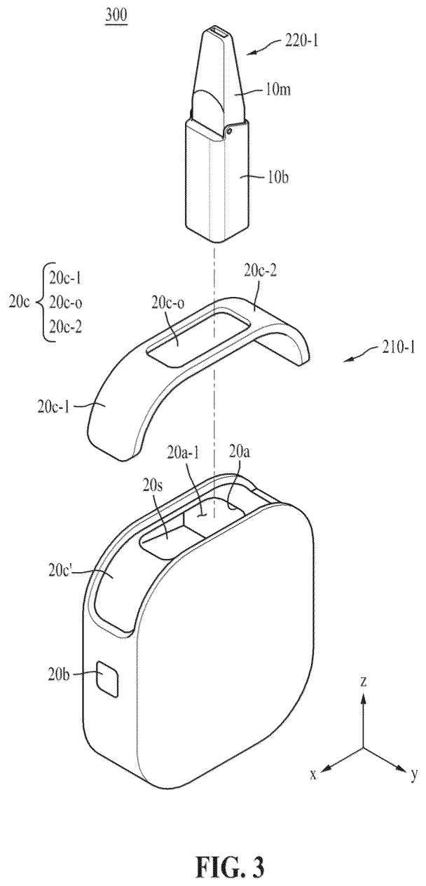

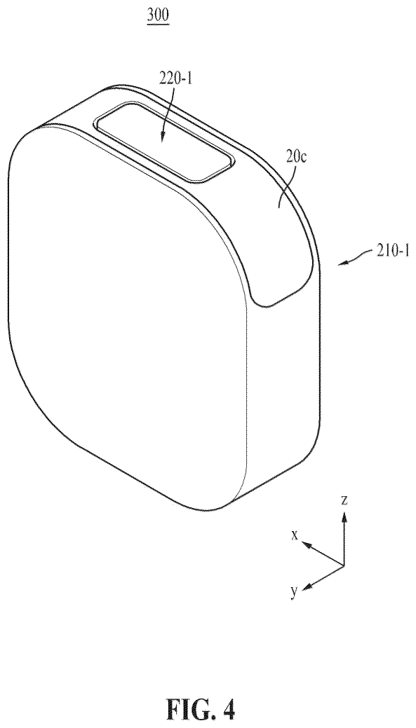

FIG. 3 is a perspective view of an aerosol generating device with a cartridge and a body separated from each other according to an example embodiment, and FIG. 4 is a perspective view of an aerosol generating device with a cartridge and a body coupled to each other according to an example embodiment.

According to an example embodiment an aerosol generating device 300 shown in FIGS. 3 and 4 may be a modified example of the aerosol generating device 200 shown in FIG. 2 (or the aerosol generating device 100 of FIG. 1), and a cartridge 220-1 and a body 210-1 shown in FIGS. 3 and 4 may be modified examples of the cartridge 220 and the body 210 shown in FIG. 2, respectively, and the repeated description thereof will therefore be omitted here.

Referring to FIGS. 3 and 4, the cartridge 220-1 may be detachably coupled to the body 210-1. For example, as at least a portion of the cartridge 220-1 is inserted into the body 210-1, the cartridge 220-1 may be coupled to the body 210-1.

The cartridge 220-1 may include a mouthpiece 10m that may move between an open position and a closed position. For example, the mouthpiece 10n may be opened and closed by rotating between the open position and the closed position.

A body portion 10b of the cartridge 220-1 may be coupled to the mouthpiece 10m through a rotation shaft. In an example, the mouthpiece 10m may be positioned at the open position. Such an open state of the mouthpiece 10m may refer to a state in which the mouthpiece 10m is stretched in a longitudinal direction (i.e., z-axis direction) of the cartridge 220-1 to easily contact the mouth of a user. Here, the longitudinal direction may refer to a direction in which the cartridge 220-1 extends the longest among several directions. In another example, the mouthpiece 10m may be positioned at the closed position. Such a closed state of the mouthpiece. 10m may refer to a state in which the mouthpiece 10m is folded in a direction transverse to the longitudinal direction of the cartridge 220-1 such that the mouthpiece 10m is received in the body 210-1 of the aerosol generating device 300.

The cartridge 220-1 may include the body portion 10b including various components required to generate an aerosol and discharge the generated aerosol. For example, the body portion 10b may include at least a portion of a storage portion, a vibrator, and an airflow path.

The body 210-1 may include a coupling portion 20a to which the cartridge 220-1 is able to be coupled. For example, the body 210-1 may include an accommodation groove 20a-1 in which at least a portion of the cartridge 220-1 may be accommodated or received. The body portion 10b of the cartridge 220-1 may be inserted into the accommodation groove 20a-1. For example, the body portion 10b of the cartridge 220-1 may be provided in the shape of a substantially rectangular prism, and corners of the rectangular prism may be chamfered or rounded. However, the shape of the body portion 10b of the cartridge 220-1 is not limited to the foregoing example but may be a cylinder or a polygonal prism.

As described above with reference to FIG. 2, the cartridge 220-1 and the body 210-1 may be coupled by at least one of a snap-tit method, a screw coupling method, a magnetic coupling method, or an interference tit method. For example, the cartridge 220-1 may include a first magnetic body and the body 210-1 may include a second magnetic body such that the cartridge 220-1 and the body 210-1 may be coupled by a magnetic force. However, the intensity of the first magnetic body and the second magnetic body may be designed in consideration of the easiness of attaching and detaching the cartridge 220-1 and the body 210-1 and/or the operational stability of the aerosol generating device 300.

The body 210-1 may include a button 20b. The button 20b may be disposed on one surface of the body 210-1. For example, the button 20b may be disposed on one surface of the body 210-1 corresponding to one end 20c-1 of a cover 20c. Using the button 20b when using the aerosol generating device 3X, the user may control an operation of the aerosol generating device 300.

The body 210-1 may further include an accommodation portion 20s capable of accommodating or receiving therein the mouthpiece 10m of the cartridge 220-1 when the mouthpiece 10m moves to the closed position. The accommodation portion 20s may be disposed on one surface of the body 210-1 and may have the shape or site corresponding to that of the mouthpiece 10m.

As shown in FIG. 4, when moved to the closed position, the mouthpiece 10m may minimize a portion of the aerosol generating device 300 protruding outside, i.e., a portion protruding outside from an outer surface of the body 210-1, at, the closed position, thereby improving portability.

In an example embodiment, the body 210-1 may further include the cover 20c coupled to a portion of the body 210-1. The cover 20c may be coupled to at least one surface of the body 210-1. For example, the cover 20c may be coupled to one side of the body 210-1 where the coupling portion 20a is positioned. Also, the cover 20c may be coupled to one side of the body 210-1 where the accommodation portion 20s is positioned.

The cover 20c may include an opening 20c-o. The cover 20c may include the opening 20c-o of a size corresponding to that of the mouthpiece 10m. For example, the opening 20c-o may have a predetermined length and width. The width of the opening 20c-o may be smaller than or equal to that of a body of the cartridge 220-1 and may be larger than or equal to that of the mouthpiece 10m. The length of the opening 20c-o may be longer than or equal to that of the mouthpiece 10m.

The cover 20c may extend from one end 20c-1 to another end 20c-2 to be disposed on a seating portion 20c′ of the body 210-1. For example, the seating portion 20c′ may have the size and shape corresponding to those of the cover 20c. The seating portion 20c′ may be a portion that extends in both directions from an inlet side of the coupling portion 20a and the accommodation portion 20s and is recessed by a predetermined depth such that the cover 20c is able to be coupled thereto.

When the cartridge 220-1 is coupled to the body 210-1, the cover 20c may be coupled to the body 210-1 after the cartridge 220-1 is coupled to the body 210-1. The cover 20c may be coupled to one side of the body 210-1 by at, least one of a snap-fit, method, an interference tit method, or a magnetic coupling method, but examples of a coupling method are not limited thereto.

The cover 20c includes the opening 20c-o through which the mouthpiece 10m may pass, and it is thus possible to protect the cartridge 220-1 without interfering with the opening and closing motion of the mouthpiece 10m while the cartridge 220-1 is coupled to the body 210-1 and maintain the coupling of the cartridge 220-1 and the body 210-1.

FIG. 4 shows the aerosol generating device 300 in which both the cartridge 220-1 and the cover 20c am both coupled to the body 210-1 and the mouthpiece 10m is positioned at the closed position. As shown, the body 210-1 includes the accommodation portion 20s having the size and shape corresponding to those of the mouthpiece 10m and the seating portion 20c′ having the size and shape corresponding to those of the cover 20c, and the cover 20c includes the opening 20L-o having the size and shape corresponding to those of the mouthpiece 10m, and thus the aerosol generating device 300 may look solid and aesthetic.

In order to detach the cartridge 220-1 from the body 210-1, the cover 20c may be first separated from the body 210-1 and then the cartridge 220-1 may be separated from the body 210-1. On the other hand, the cover 20c may be installed after the body 210-1 and the cartridge 220-1 are coupled.

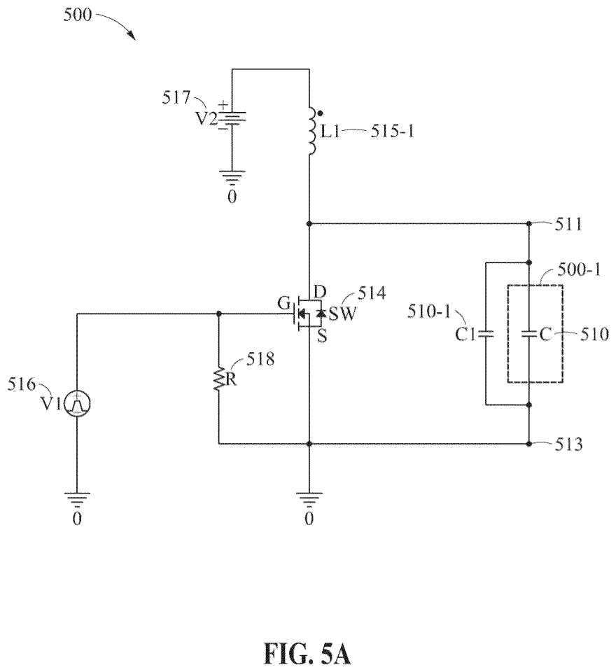

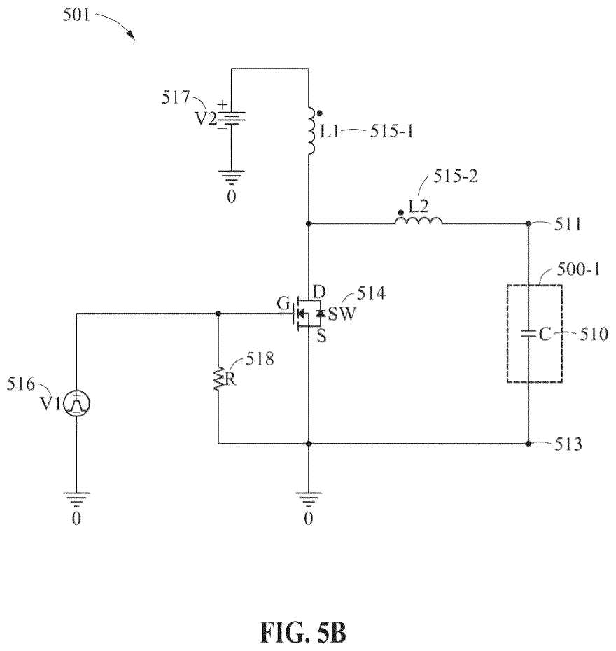

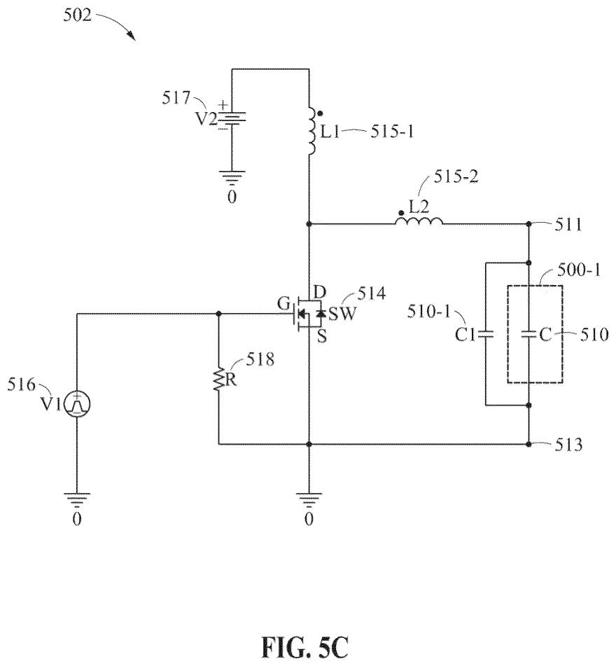

FIG. 5a illustrates a drive circuit including a capacitor according to an example embodiment.

Referring to FIG. Sa, according to an example embodiment, a vibrator C 510 (e.g., the atomizer 150 of FIG. 1 or the vibrator 250 of FIG. 2) may be included in a cartridge 500-1 (e.g., the cartridge 220 of FIG. 2). When the cartridge 220 is mechanically coupled to the body 210, the vibrator 510 may be electrically connected to a first electrical contact point 511 and a second electrical contact point 513 of a drive circuit 500 (e.g., the drive circuit 138 of FIG. 1 or the drive circuit 212 of FIG. 2). When the first electrical contact point 511 and the second electrical contact point 513 are connected through the vibrator 510, the controller 214 may recognize the coupling of the vibrator 510 and supply power to the drive circuit 500.

More specifically, the drive circuit 500 may be connected to a first end of the vibrator 510 through the first electrical contact point 511 and a second end of the vibrator 510 through the second electrical contact point 513.

According to an example embodiment, the cartridge 500-1 may include the vibrator C 510. When the cartridge 500-1 is mechanically coupled to the body 210, the cartridge 500-1 may be electrically connected to the drive circuit 50.

According to an example embodiment, an inductor L1 515-1 may be connected between the first electrical contact point 511 and a second power source 517. A first end of the inductor L1 515-1 may be connected to the first electrical contact point 511 and a second end of the inductor L1 515-1 may be connected to the second power source 517.

According to an example embodiment, a drain terminal of a switch 514 may be connected to the first electrical contact point 511 and a source terminal thereof may be connected to the ground. According to an example embodiment, the switch 514 may be a field-effect transistor (FET)-based switch.

According to an example embodiment, the first power source 516 may provide a voltage to a gate terminal of the switch 514. According to an example embodiment, the first power source 516 may provide an AC voltage to the gate terminal of the switch 514. For example, a peak value of the AC voltage may be less than or equal to 4 volts (V) but is not limited thereto.

According to an example embodiment, the second power source 517 may provide a voltage to the second end of the inductor L1 515-1. The second power source 517 may provide a DC voltage to the drain terminal of the switch 514 and the first end (i.e., the first electrical contact point 511) of the vibrator 510. For example, the DC voltage may be less than or equal to 0.15V (e.g., 10V but is not limited thereto.

According to an example embodiment, a first resistor 518 may be connected between the gate terminal of the switch 514 and the ground.

According to an example embodiment, the vibrator 510 included in the cartridge 500-1 may have a natural frequency which varies according to a physical characteristic of the vibrator 510. As a frequency of a signal provided to the vibrator 510 is similar to the natural frequency, stronger resonance may occur. That is, when the vibrator 510 receives power through the drive circuit 500, the strongest resonance may occur if a vibration frequency of the drive circuit 500 matches the natural frequency of the vibrator 510. The vibration frequency of the drive circuit 500 matching the natural frequency of the vibrator 510 may be referred to as a resonance frequency or a characteristic frequency. The vibration frequency of the drive circuit 500 may be the same as a frequency of a signal (e.g., voltage) applied across the vibrator 510.

According to an example embodiment, the drive circuit 500 may further include a capacitor C1 510-1. A first end of the capacitor C1 510-1 may be connected to the first electrical contact point 511, and a second end of the capacitor C1 510-1 may be connected to the second electrical contact point 513. The capacitor C1 510-1 of the drive circuit 500 may be a variable capacitor, and a capacitance value of the capacitor C1 510-1 may be set such that the vibration frequency matches the natural frequency of the vibrator 510.

If the capacitor C1 510-1 of the drive circuit 500 is not a variable capacitor, one or more capacitors may be connected to the capacitor C1 510-1 to have a desired capacitance value. The one or more capacitors each may be connected in parallel with the vibrator 510 and the capacitor C1 510-1. For example, referring to FIG. 5a, the one or more capacitors may be connected in parallel with the capacitor C1 510-1 in the drive circuit 500. However, the connection method and the number of the one or more capacitors may vary according to embodiments.

According to an example embodiment, the one or more capacitors may be connected in series to a switch (not shown). For example, the first end of the capacitor 510-1 may be connected to the first electrical contact point 511, the second end of the capacitor 510-1 may be connected to one end of the switch, and another end of the switch may be connected to the second electrical contact point 513. By turning on/off the switch, a parallel connection between the vibrator 510 and a capacitor connected in series to the switch may be controlled.

According to an example embodiment, the drive circuit 500 may generate vibration of the vibrator 510 by using a lower switch input voltage than a typical boost converter-type drive circuit. For example, a typical boost converter-type drive circuit may require a switch input voltage of 17V to apply a high voltage to a vibrator, but the drive circuit 500 according to an example embodiment may only use a switch input voltage of 10V to apply the same voltage to the vibrator 510. That is, the drive circuit 500 according to an embodiment is more effective in generating aerosols.

Since a voltage applied to the switch of the drive circuit 500 is a voltage (e.g., 10V) directly applied to a drain of the switch, a switch is not required to withstand a high voltage. Accordingly, the drive circuit 500 may use a switch with a low Rds(on) resistance, and thus issues such as overheating may be resolved.

FIG. 5b illustrates a drive circuit including a matching inductor according to an example embodiment.

The description provided above with reference to FIG. 5a may also apply to the description provided below with reference to FIG. 5b, and any repeated description related thereto will be omitted for the convenience of description. The drive circuit 500 of FIG. 5a and a drive circuit 501 of FIG. 5b differ in the presence or absence of the capacitor 510-1 and a matching inductor 515-2, but the remaining components (511 to 515-1 and 516 to 518) may have the same roles and functions as described above.

According to an example embodiment, the drive circuit 501 may further include the matching inductor L2 515-2. A first end of the matching inductor L2 515-2 may be connected to the first electrical contact point 511, and a second end of the matching inductor L2 515-2 may be connected to the first end of the inductor 515-1. The matching inductor 12 515-2 of the drive circuit 501 may be a variable inductor, and an inductance value of the matching inductor L2 515-2 may be set such that the vibration frequency resonates with the natural frequency of the vibrator 510.

If the matching inductor L2 515-2 of the drive circuit 501 is not a variable inductor, one or more matching inductors may be connected to the matching inductor L2 515-2 to have a desired inductance value. The one or more matching inductors each may be connected in parallel with the matching inductor L2 515-2. However, the connection method and the number of the one or more matching inductor, may vary according to embodiments.

According to an example embodiment, the one or more matching inductors may be connected in parallel with a switch (not shown. For example, the first end of the matching inductor 515-2 may be connected to one end of the switch, and another end of the switch may be connected to the second end of the matching inductor 515-2. By turning on/off the switch, a serial connection between the vibrator 510 and a matching inductor may be controlled. When the switch connected in parallel with an inductor is turned on, most of the current in a drive circuit flows through the switch, and thus no current may flow through the inductor. When the switch is turned off, most of the current in a drive circuit flows through the inductor and no current flows through the switch direction, and thus the inductor may operate.

FIG. 5c illustrates a drive circuit including a matching inductor and a capacitor according to an example embodiment.

The description provided above with reference to FIGS. 5a and 5b may apply to the description provided with reference to FIG. 5c, and any repeated description related thereto will be omitted here.

According to an example embodiment, a drive circuit 502 of FIG. 5c may include both the capacitor 510-1 of the drive circuit 500 shown in FIG. 5a and the matching inductor 515-2 of the drive circuit 501 shown in FIG. 5b.

According to an example embodiment, one or more capacitors 510-1 may be connected in parallel with the vibrator 510 and one or more matching inductors 515-2 may be connected in series to the vibrator 510 such that a vibration frequency of the drive circuit 502 matches the natural frequency of the vibrator 510.

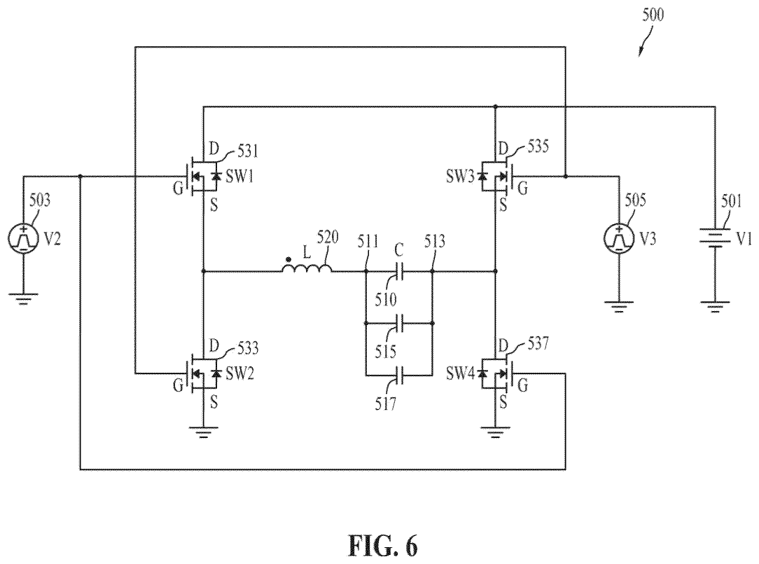

FIG. 6 illustrates a full bridge drive circuit according to an example embodiment.

Hereinafter, when two elements are “connectable,” it refers to a configuration where the elements get connected to each other when a detachable part (e.g., a cartridge) of the aerosol generating device including one element is coupled to another detachable part (i.e., a body) of the aerosol generating device including the other element.

According to an example embodiment, a drive circuit 50 (e.g., the drive circuit 138 of FIG. 1 or the drive circuit 212 of FIG. 2) may include, for supplying power to a vibrator 510 (e.g., the atomizer 150 of FIG. 1 or the vibrator 250 of FIG. 2), a first electrical contact point 511 connectable to a first end of the vibrator 510, a second electrical contact point 513 connectable to a second end of the vibrator 510, one or more capacitors (e.g., a first capacitor 515 and a second capacitor 517) connected in parallel with the first electrical contact point 511 and the second electrical contact point 513 (wherein a first end of the one or more capacitors is connected to the first electrical contact point 511 and a second end of the one or more capacitors is connected to the second electrical contact point 513), an inductor 520 (e.g., a coil) connected to the first electrical contact point 511 (wherein a first end of the inductor 520 is connected to the first electrical contact point 511), a first switch SW1 531 having a source terminal connected to a second end of the inductor 520, a second switch SW2 533 having a drain terminal connected to the second end of the inductor 520 (wherein a source terminal of the second switch 533 is connected to the ground), a third switch SW3 535 having a source terminal connected to the second electrical contact point 513, a fourth switch SW4 537 having a drain terminal connected to the second electrical contact point 513 (wherein a source terminal of the fourth switch 537 is connected to the ground), a first power source V1 501 configured to provide a voltage to the drain terminal of the first switch 531 and the drain terminal of the third switch 535, a second power source V2 503 configured to provide a voltage to a gate terminal of the first switch 531 and a gate terminal of the forth switch 537, and a third power source V3 505 configured to provide a voltage to a gate terminal of the second switch 533 and a gate terminal of the third switch 535. For example, the first switch 531, the second switch 533, the third switch 535, and the fourth switch 537 may each be an FET-based switch.

According to an example embodiment, the vibrator 510 may be included in a cartridge. When the cartridge is mechanically coupled to a body, the vibrator 510 may be electrically connected to the first electrical contact point 511 and the second electrical contact point 513 of the drive circuit 500 included in the body. When the first electrical contact point 511 and the second electrical contact point 513 are connected through the vibrator 510, the controller 214 may recognize the coupling of the vibrator 510 and supply power to the vibrator 510 through the drive circuit 500.

According to an example embodiment, the one or more capacitors may be included in a body (e.g., the drive circuit 500). When the cartridge is mechanically coupled to the body, the vibrator 510 may be electrically connected to the first electrical contact point 511 and the second electrical contact point 513 of the drive circuit 500, and thus the one or more capacitors may be connected in parallel with the vibrator 510. For example, referring to FIGS. 5a-5c, the one or more capacitors may include the first capacitor 515 and the second capacitor 517. This is, however, provided as an example, and the number of capacitors to be connected in parallel with the vibrator 510 is not limited to the illustrated example.

According to an example embodiment, the vibrator 510 included in the cartridge may have a natural frequency which varies according to a physical characteristic of the vibrator 510. As a frequency of a signal provided to the vibrator 510 become closer to the natural frequency, the resonance may become stronger. That is, when the vibrator 510 receives power through the drive circuit 500, the strongest resonance may occur if a vibration frequency of the drive circuit 500 matches the natural frequency of the vibrator 510. In this case, the vibration frequency of the drive circuit 500 may be represented as a resonance frequency or a characteristic frequency. The vibration frequency of the drive circuit 500 may represent a frequency of a signal (e.g., voltage) applied across the vibrator 510. Since the natural frequency of the vibrator 510 may vary according to the physical characteristic of the vibrator 510, the vibration frequency of the drive circuit 500 may al-o vary after the vibrator 510 is electrically connected. That is, while the vibration frequency of the drive circuit 500 is fixed, the strength of the resonance of the vibrator 510 may vary according to the natural frequency of the vibrator 510 of the cartridge to be coupled.

According to an example embodiment, by connecting the one or more capacitors in parallel with the vibrator 510, the vibration frequency of the drive circuit 500 may be adjusted to match the natural frequency of the vibrator 510. As such, the resonance may occur, and thus the vibration efficiency of the vibrator 510 may be increased and overheating may be prevented.

According to an example embodiment, the one or more capacitors may be connected in series to a switch (not shown). For example, a first end of the first capacitor 515 may be connected to the first electrical contact point 511, a second end of the first capacitor 515 may be connected to one end of the switch, and another end of the switch may be connected to the second electrical contact point 513. By turning on/off the switch, a parallel connection between the vibrator 510 and a capacitor connected in series to the switch may be controlled.

According to an example embodiment, the first power source 501 may provide a DC voltage to the drain terminal of the first switch 531 and the drain terminal of the third switch 535. For example, the DC voltage may be less than or equal to 15V (e.g., 10V) but is not limited thereto.

According to an example embodiment, the second power source 503 may provide a first AC voltage to the gate terminal of the first switch 531 and the gate terminal of the fourth switch 537, and the third power source 505 may provide a second AC voltage to the gate terminal of the second switch 533 and the gate terminal of the third switch 535. For example, a peak value of the first AC voltage and a peak value of the second AC voltage may each be less than or equal to 4V, but are not limited thereto.

According to an example embodiment, the second power source 503 and the third power source 505 may operate alternately. That is, the second power source 503 and the third power source 505 may not operate simultaneously. A voltage between the first end and the second end of the vibrator 510 provided by the drive circuit 500 may be greater than or equal to 100V, but is not limited thereto.

When the drive circuit 500 is used, it is possible to generate a high voltage for a vibration of the vibrator 510 by applying a lower voltage (e.g., 10V) to a switch than when a boost converter-type drive circuit is used.

A voltage applied to a switch of the drive circuit 500 is a voltage (e.g., 10V) directly applied to a drain of the switch, and thus there is no need for a switch capable of withstanding a high voltage. Accordingly, a switch with a low Rds(on) resistance may be used in the drive circuit 500, and thus issues such as component overheating may be resolved.

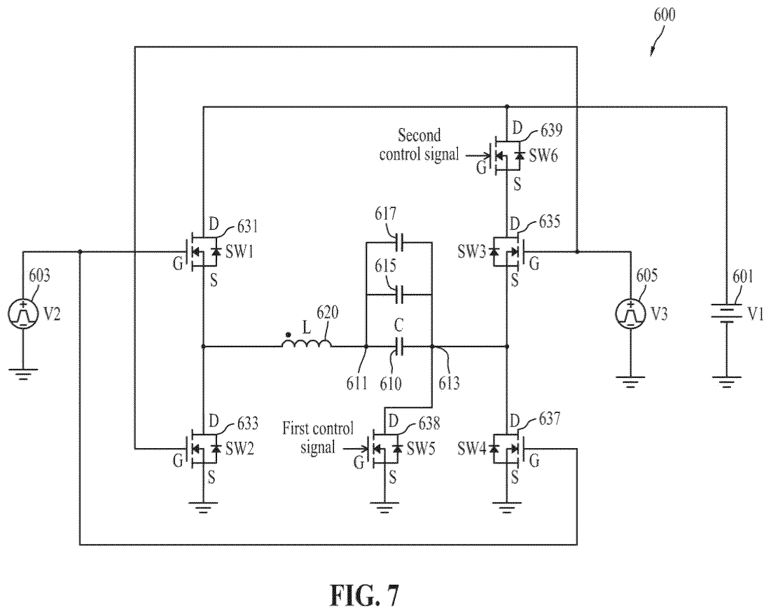

FIG. 7 illustrates a drive circuit for switching between a full-bridge mode and a half-bridge mode according to an example embodiment.

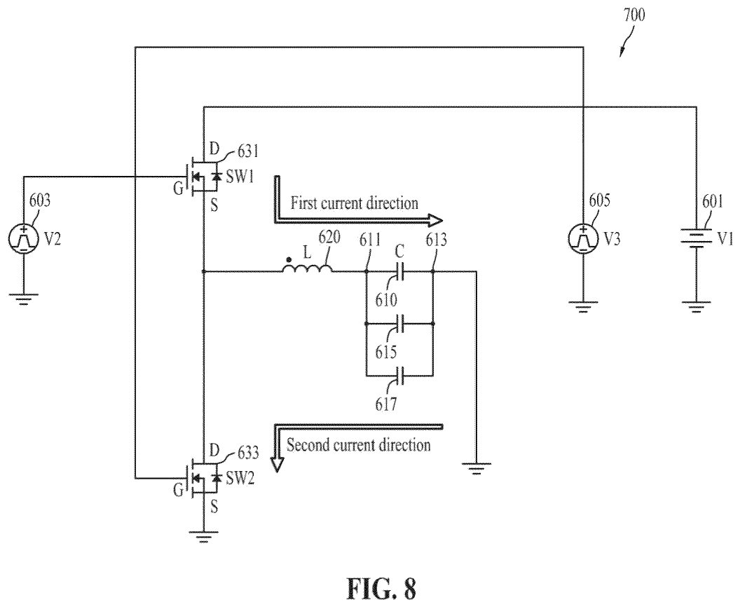

According to an example embodiment, when compared to the drive circuit 500 described above with reference to FIG. 5a, 5b, or 5c, the drive circuit 600 may further include a fifth switch 638 connected to a second electrical contact point 613 and a sixth switch 639 disposed between a drain terminal of a third switch 635 and a first power source 601 (wherein a source terminal of the sixth switch 639 is connected to the drain terminal of the third switch 635, and a drain terminal of the sixth switch 639 is connected to the first power source 601). For example, a first control signal provided to a gate terminal of the fifth switch 638 and a second control signal provided to a gate terminal of the sixth switch 639 may be different from each other, and the first control signal and the second control signal may be provided by the controller 214. When a first control signal is LOW and a second control signal is HIGH, the drive circuit 600 may operate in a full-bridge mode. Conversely, when the first control signal is HIGH and the second control signal is LOW, the drive circuit 600 may operate in a half-bridge mode. FIG. 8 shows an equivalent circuit 700 of the drive circuit 600 that operates in the half-bridge mode.

According to an example embodiment, the drive circuit 600 may further include one or more capacitors (e.g., a first capacitor 615 and a second capacitor 617). The one or more capacitors may be disposed in the drive circuit 600 such that they are connected in parallel with a vibrator 610 of a cartridge when the vibrator 610 is connected to the drive circuit 600.

FIG. 8 illustrates an equivalent circuit of a drive circuit operating in a half-bridge mode according to an example embodiment.

According to an example embodiment, when a second power source 603 and a third power source 605 operate alternately, a direction of a current flowing through the vibrator 610 may change accordingly.

In the half-bridge mode, when compared to the full-bridge mode, a maximum voltage applied to the vibrator 610 may be reduced, and total power consumed by the drive circuit 600 may also be reduced. Accordingly, when the aerosol generating device 200 needs to generate a relatively smaller amount of aerosol, the half-bridge mode may be used.

A mode of operating a drive circuit described above with reference to FIGS. 7 and 8 is provided as an example, and the drive circuit according to another embodiment may be operable in a full-bridge mode, a half-bridge mode, or other operation modes in which the number of switches is two or less. Further, embodiments are not limited thereto.

The example embodiments described herein may be implemented using a hardware component, a software component, and/or a combination thereof. A processing device may be implemented using one or more general-purpose or special-purpose computers, such as, for example, a processor, a controller, and an arithmetic logic unit (ALU), a DSP, a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is singular: however, one of ordinary skill in the art will appreciate that a processing device may include multiple processing elements and multiple types of processing elements. For example, the processing device may include a plurality of processor, or a single processor and a single controller. In addition, different processing configurations ae possible, such as, parallel processors.

The software may include a computer program, a piece of code, an instruction, or one or more combinations thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape: optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an under-standing of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

1. A drive circuit comprising:
a first electrical contact point that is connectable to a first end of a vibrator included in a cartridge and a second electrical contact point that is connectable to a second end of the vibrator;
one or more capacitors connected in parallel between the first electrical contact point and the second electrical contact point, wherein a first end of the one or more capacitors is connected to the first electrical contact point and a second end of the one or more capacitors is connected to the second electrical contact point;
an inductor connected to the first electrical contact point, wherein a first end of the inductor is connected to the first electrical contact point;
a switch having a drain terminal connected to the first electrical contact point, wherein a source terminal of the switch is connected to a ground;
a first power source configured to provide a voltage to a gate terminal of the switch;
a second power source configured to provide a voltage to a second end of the inductor; and
a resistor connected between the gate terminal of the switch and the ground.

2. The drive circuit of claim 1, further comprising:
one or more matching inductors connected in parallel between the first electrical contact point and the first end of the inductor, wherein a first end of the one or more matching inductors is connected to the first electrical contact point, and a second end of the one or more matching inductors is connected to the drain terminal of the switch.

3. The drive circuit of claim 1, further comprising:
a switch connected between the first end of the one or more capacitors and the first electrical contact point, or between the second end of the one or more capacitors and the second electrical contact point.

4. The drive circuit of claim 2, further comprising:
a switch connected in parallel with the one or more matching inductors.

5. The drive circuit of claim 1, wherein the first power source is configured to provide an alternating current (AC) voltage to the gate terminal of the switch.

6. The drive circuit of claim 1, wherein the second power source is configured to provide a direct current (DC) voltage to the second end of the inductor and the first end of the vibrator.

7. An electronic cigarette comprising the drive circuit of claim 1.

8. A drive circuit of an electronic device, comprising:
a first electrical contact point that is connectable to a first end of a vibrator included in a cartridge and a second electrical contact point that is connectable to a second end of the vibrator;
one or more matching inductors connected to the first electrical contact point, wherein a first end of the one or more matching inductors is connected to the first electrical contact point and the one or more matching inductors are connected in parallel;
an inductor connected to a second end of the one or more matching inductors, wherein a first end of the inductor is connected to the second end of the one or more matching inductors;
a switch having a drain terminal connected to the second end of the one or more matching inductors, wherein a source terminal of the switch is connected to a ground;
a first power source configured to provide a voltage to a gate terminal of the switch;
a second power source configured to provide a voltage to a second end of the inductor; and
a resistor connected between the gate terminal of the switch and the ground.

9. An electronic device comprising:
a body configured to be connected to a cartridge,
wherein the body comprises:
a driver circuit configured to, when the cartridge is connected to the body, drive a vibrator of the cartridge; and
a controller configured to control an operation of the drive circuit, and
wherein the drive circuit comprises:
at least one of a first circuit and a second circuit,
wherein the first drive circuit comprises:
a first electrical contact point that is connectable to a first end of the vibrator and a second electrical contact point, that is connectable to a second end of the vibrator;
one or more capacitors connected in parallel between the first electrical contact point and the second electrical contact point, wherein a first end of the one or more capacitors is connected to the first electrical contact point and a second end of the one or more capacitors is connected to the second electrical contact point;
an inductor connected to the first electrical contact point, wherein a first end of the inductor is connected to the first electrical contact point;
a switch having a drain terminal connected to the first electrical contact point, wherein a source terminal of the switch is connected to a ground;
a first power source configured to provide a voltage to a gate terminal of the switch;
a second power source configured to provide a voltage to a second end of the inductor; and
a resistor connected between the gate terminal of the switch and the ground
wherein the second drive circuit comprises:
a first electrical contact point that is connectable to a first end of the vibrator and a second electrical contact point that is connectable to a second end of the vibrator;
one or more matching inductors connected to the first electrical contact point, wherein a first end of the one or move matching inductors is connected to the first electrical contact point and the one or more matching inductors are connected in parallel;
an inductor connected to a second end of the one or more matching inductors, wherein a first end of the inductor is connected to the second end of the one or more matching inductors;
a switch having a drain terminal connected to the first end of the one or more matching inductors, wherein a source terminal of the switch is connected to a ground;
a first power source configured to provide a voltage to a gate terminal of the switch;
a second power source configured to provide a voltage to a second end of the inductor; and
a resistor connected between the gate terminal of the switch and the ground.
